(19) United States
(12) Patent Application Publication
(10) Pub. No.: US 2007/0014441 A1
(43) Pub. Date: Jan. 18, 2007

(54) Fingerprint identification assembly using total reflection to indentify pattern of the fingerprint

(76) Inventors: Jung-Chun Wu, Taichung City (TW); Jyh-Long Chern, Taichung City (TW); Ching-Shan Dai, Taichung City (TW); Yung-Wen Lin, Taichung City (TW); Jyh-Der Hwang, Taichung City (TW)

Correspondence Address: HERSHKOVITZ & ASSOCIATES, 2845 DUKE STREET, ALEXANDRIA, VA, 22314, US

(21) Appl. No.: 11/179,519

(22) Filed: Jul. 13, 2005

(51) Int. Cl. G06K 9/00

(52) U.S. Cl. 382/124

(57) ABSTRACT

A fingerprint identification assembly includes a body having an objective lens mounted on top of the body for receiving thereon a fingertip and a first reflective lens mounted on a bottom of the body to receive reflected light from the objective lens, a light source emitting light to the first reflective lens and a sensing device integrally formed with the body and having a second reflective lens to receive the reflected light from the first reflective lens and a sensor to receive the reflected light from the second reflective lens so as to compare the received reflected light with information stored inside the sensor.

### BACKGROUND OF THE INVENTION

1. Field of the Invention

The present invention relates to a fingerprint identification assembly, and more particularly to a fingerprint identification assembly having a first reflection lens and a second reflection lens such that a total reflection of the pattern of the fingerprint on top of an object lens of the assembly is accomplished and sensed by a sensor of the assembly.

2. Description of Related Art

Fingerprint identification is probably one of the oldest and best established methods to identify a person. It is of the field of biometrics, i.e. identifying people by measuring or sensing parts of a human body, which is of importance for a variety of applications. Many automated techniques are currently in use or under development, including palm print reading, finger pore reading, hand geometry identifying and iris, retina or face recognition. Among which, fingerprint identification is rather straightforward and it now promises to find wider acceptance as it is convenient and a secure alternative to typed password, keys or signature for access to limited area or information.

Basically the identification task involves determination of the identity of an unknown person based on a fragment of a fingerprint pattern, or verification of the identity of a known person to a level of certainty based on the pattern of the specific fingerprint. Exact identification of fingerprint characteristics is desired for universal need, i.e., different machines can recognize the characteristics. On the other hand, in many situations, the identifications are not necessarily universal, but require clear resolution only. Human fingertips have distinctive patterns of curved ridges, with a period of about 0.5˜1.0 mm depth of about 0.1 mm. Finger tissue scatters red light with a diffuse reflectivity of about 50%, and the refractive index of a finger is about 1.51. It may be desirable to have as large a field of view as possible with minimum distortion to provide more features for identification and more margin of error in finger placement for the need of universal identification. On the other hand, with a touch platform on which fingerprint will be identified, the effective size of fingerprint could be about 10 mm, but the size of system size has to be rather small, less than 10 mm for cellular phone application for example. Many kinds of fingerprint reorganization devices have been developed. They are mainly first to record the ridge patterns, and software extracts the coordinates and classes of features like ridge ends and bifurcations (called “minutiae”). With software, distortion can be corrected, but image blur is difficult to remove. There is also a line of tiny pores on the ridges that is more difficult to resolve, but can be used to provide more information for identification. U.S. Pat. Appln. No. 2002/003892 from M. Iwanaga proposed a novel method of fingerprint imaging in air for a cellular phone. However, for a finger in air, ridges may be seen by the specular reflection of light from a localized source, but image contrast is limited by the underlying scattering, and tipping of the finger so it is not perfectly flat on the imaging surface. The rounded shape of the finger can cause unacceptable distortion of the image. In contrast, when using the contact methods, the user flattens the fingertip against a surface (touch platform); then ridges and valleys can be distinguished by height differences between the ridges and the valleys. Identification using the contact method has been widely used. There are electronic sensors that measure capacitance variation, and optical sensors that view the finger pressed against a transparent platen or window. Optical contact sensors record changes of specular reflectance, imaged onto a sensor such as a CCD or CMOS detector array. The pixel size of optical contact sensor can be down to −5 μm and the sensor can be quite small with a suitable quantity of pixels for sufficient resolution capability.

Most fingerprint identification devices are bright-field devices, that is, they produce a dark fingerprint ridge pattern on a light background. To produce a fingerprint image with acceptable contrast, additional optical components are required to generate a uniformly bright background. Because of the additional components, it is difficult to make a compact bright-field device. Betensky of U.S. Pat. No. 5,900,993, issued on May 4, 1999 and entitled “Lens System for Use in Fingerprint Detection” describes a lens system in which a first and second lens in combination with a third cylindrical lens are employed to reduce optical distortion. However, an approach using cylindrical lenses requires additional components and inherently complicates the alignment of the lens system because a lack of symmetry causes failure in the alignment process in handling an extra degree of freedom in lens placement. In viewing the needs of compact fingerprint identification in small volumes, such as that for a keyboard, Clark et. al. further demonstrate a compact design with a focal lens system and dark-field illumination in U.S. Pat. No. 6,643,390, issued in November 2003.

What is needed in emergent consumer application is a compact fingerprint identification device having suitable image quality with minimum distortion which can be adapted for use in a small compartment, such as a cellular phone or an ultra-thin electronic device or personal belongings, and which contains a minimum number of components so as to facilitate production.

To overcome the shortcomings, the present invention tends to provide an improved compact fingerprint identification assembly to mitigate the aforementioned problems.

### SUMMARY OF THE INVENTION

The primary objective of the present invention is to provide a fingerprint identification system using total reflection to identify pattern of the fingerprint.

In one aspect of the present invention, the fingerprint identification assembly has a body provided with a light source to emit evenly distributed light, an objective lens made of transparent material such as glass or acrylic resin and a first concave lens for receiving light reflected from the objective lens and transmitting the reflected light outward and a sensing device securely connected to the body and having a second concave lens corresponding to the first concave lens and a sensor to detect and receive light from the second concave lens such that due to height differences between ridges and valleys of a fingerprint, distinctive light zones are formed and the distinctions are transmitted to the first concave lens, the second concave lens and the sensor for identification recognition.

Other objects, advantages and novel features of the invention will become more apparent from the following detailed description when taken in conjunction with the accompanying diagrams.

### BRIEF DESCRIPTION OF THE DRAWINGS

FIG. 1 is a schematic view showing the preferred embodiment of the present invention;

FIG. 2A is a schematic view of a different embodiment of the present invention;

FIG. 2B is a schematic view of still a different embodiment relative to the embodiment shown in FIG. 2A; and

FIG. 2C is a schematic view showing a variation of the objective lens of the present invention.

### DETAILED DESCRIPTION OF THE PREFERRED EMBODIMENT

Diagram 1 is a schematic diagram of the lens head in several preferred embodiments

[image]

Diagram 2 (a) preferred embodiment with even-number reflective surfaces; (b) preferred embodiment with odd-number reflective surface

[image]

(note that above figures (a)/(b) should be in the form as shown below)

[image]

Diagram 3 (a) Ray-intercept diagram (b) MTF (c) distortion for a preferred embodiment in which the lens prescription is shown in Table 1

[image]

[image]

Diagram 4 (a) Ray-intercept diagram (b) distortion for a preferred embodiment in which the lens prescription is shown in Table 2

[image]

Diagram 5 (a) Ray-intercept diagram (b) distortion for a preferred embodiment in which the lens prescription is shown in Table 3

[image]

Diagram 6 fingerprint imaging device with light source

[image]

Using the contact method known in art, the finger can be viewed or illuminated obliquely, to increase contrast by total internal reflection (TIR). Bright-field or dark-field illumination may be chosen. With bright-field illumination, light is directed into the aperture stop. If there is no contact, light totally reflects from the platen surface. When a finger is in contact, TIR does not occur, and most of the light is scattered out of the imaging path, so finger ridges appear dark. In dark-field illumination, the detector receives scattered light from the contact regions of the finger beyond the critical angle. Where there is no contact, the finger is not visible to the sensor. Finger ridges appear light. Both illumination schemes can be adopted in current invention. Essentially, the fingerprint pattern on touch platform is virtually as radiance object and the lens reduces the size of this “source” image so as to fit the specification of the image sensor with suitable imaging performance.

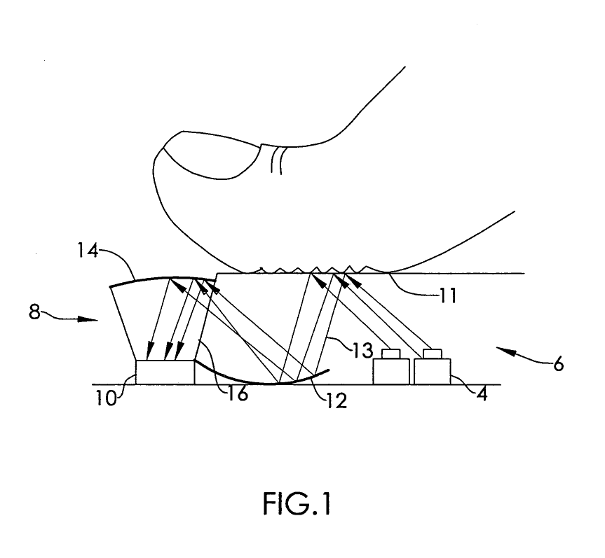

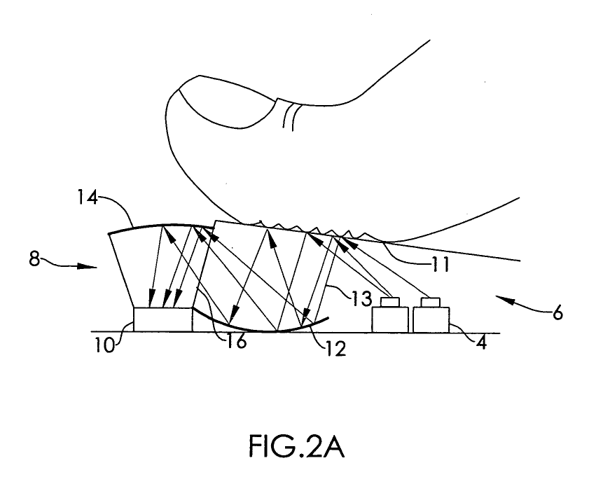

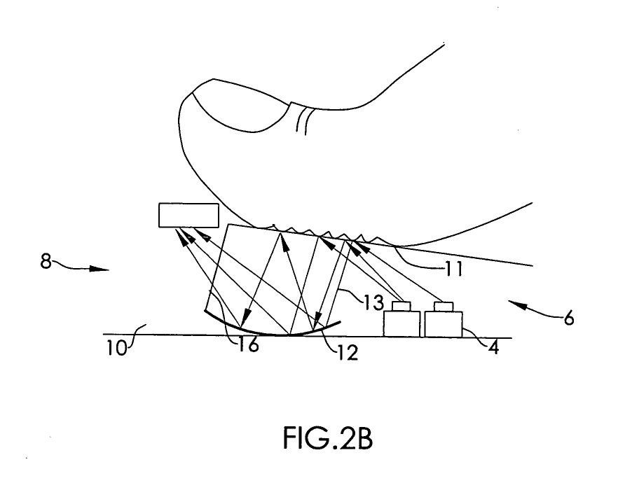

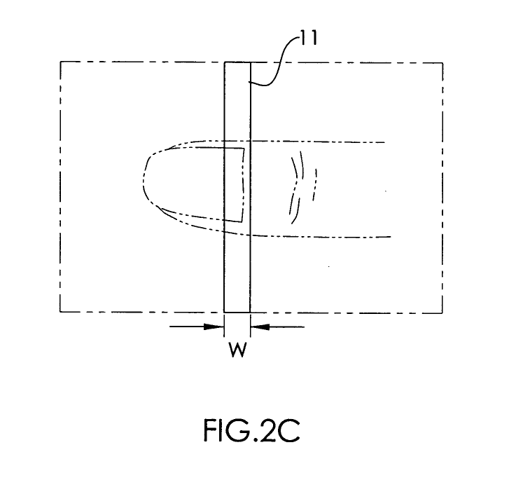

To reduce volume size and to acquire enough resolution, multiple reflective surfaces are employed in the lens. Referring to FIG. 1, in a preferred embodiment, the fingerprint illuminated by a light source (not shown) and re-illuminated to the sensor by multiple reflective surfaces successively from first surface 1, the second surface and then to the image sensor. All reflective surfaces are with coating to avoid loss. Additional surfaces can be added in between the second surface and the image plane as shown in FIG. 2 in which two types of configuration can be seen. FIG. 2 (a) is a symmetrical configuration in which the reflective surfaces are of even number while FIG. 2(b) is an asymmetrical configuration in which the number of reflective surfaces is odd. More numbers of reflective surfaces provide more degree of freedom to improve the performance of imaging for the lens.

In embodiments, the light source is adopted with 720 nm for a specific red LED, the object size is 10 mm. The imaging sensor is working for an f/#=3.5; typical image size is a quarter of object size or smaller. The lens thickness is generally less than 10 mm. The lens material is Acryl. For aspheric surface, the sag equation is described by

$$z = \frac{c {y}^{2}}{1 + \sqrt{1 - ( 1 + κ ) {c}^{2} {y}^{2}}} + A D {y}^{4} + A E {y}^{6} + A F {y}^{8} + A G {y}^{10}$$

where c is the surface curvature (c=1/r, r is the radius of curvature), y is the radial distance from the axis, and k is the conic constant, AD, AE, AF, and AG are the fourth, sixth, eighth, and tenth order deformation coefficients.

To illustrate the embodiment of symmetrical configuration, a lens prescription shown in Table 1 is included.

| | Radius of | | |
|---|---|---|---|
| | curvature | | |
| Surface | (mm) | Thickness (mm) | Comments |
| Obj | 0 | 7.6 | |
| 1 | 3.597811 | −7.6 | Reflective |
| 2 | 9.618052 | 10 | Reflective |
| Img | 0 | | |

The ray-intercept diagram is shown in Diagram3(a) and the MTF over the full object size at three different spatial frequencies (2 lp/mm, 6 lp/mm and 10 lp/mm) is shown in Diagram3(b). The effect of distortion is shown in Diagram3(c) based on a object illumination.

Different layout with a shorter lens size is demonstrated and the lens prescription is shown in Table 2

| | Radius of | | |
|---|---|---|---|
| | curvature | | |
| Surface | (mm) | Thickness (mm) | Comments |
| Obj | 0 | 5.0 | |
| 1 | 12.285095 | −5.0 | Reflective |
| 2 | 5.194983 | 3.704574 | Reflective |
| Img | 0 | | |

The ray-intercept diagram is shown in Diagram4(a) and the effect of distortion is shown in Diagram4(b) based on a object illumination.

Additional improvement can be achieved by including aspheric surface. A lens prescription shown in Table 3 is included.

| | Radius of | | |
|---|---|---|---|
| | curvature | | |
| Surface | (mm) | Thickness (mm) | Comments |
| Obj | 0 | 6.59 | |
| 1 | 6.10643 | −6.59 | Reflective |
| 2 | 7.664650 | 6.6 | Reflective |
| | | | Aspheric coefficients: |
| | | | AD = −8.9864 × 10⁻³ |
| | | | AE = 2.5227 × 10⁻² |
| | | | AF = −1.6825 × 10⁻² |
| Img | 0 | | |

The ray-intercept diagram is shown in Diagram5(a) and the effect of distortion is shown in Diagram5(b) based on an object illumination.

With the lens illustrated above, an object of fingerprint can be on the touch platform and the light from the source, says LED, will illuminate on the fingerprint. Because the reflection, a part of scattered will be reflected by the reflective surface and collected by the image sensor.

With reference still to FIG. 1, it is noted that the fingerprint identification assembly in accordance with the present invention includes a body (6) provided with a light source (4) to emit evenly distributed light, an objective lens (11) mounted on top of the body (6) and made of transparent material such as glass or acrylic resin and a first concave lens (12) mounted on a bottom face of the body (6) for receiving light reflected from the objective lens (11) and transmitting the reflected light outward and a sensing device (8) securely connected to the body (6) and having a second concave lens (14) corresponding to the first concave lens (12) and a sensor (10) to detect and receive light from the second concave lens (14) such that due to height differences between ridges and valleys of a fingerprint, distinctive light zones are formed and the distinctions of the specific fingerprint are transmitted to the first concave lens (12), the second concave lens (14) and the sensor (10) for identification recognition. From this application, it is noted that the objective lens (11) is parallel to a ground surface. However, from the depiction of FIG. 2A, it is noted that although the objective lens (11) is inclined relative to the ground surface, the purpose of the present invention can still be accomplished.

It is to be noted that additional lenses may be added to the structure of the present invention so as to increase fingerprint clearness. That is, the number of lenses used may be odd and may be even.

From the above description, it is noted that when the light source (4) is actuated, light from the light source (4) travels into a reflection effective area (13) created by the first concave lens (12) and arrives at the objective lens (11). Because a finger is placed on top of the objective lens (11), different light zones, i.e. bright areas and dark areas, are formed due to the ridges and valleys of the fingerprint. As a consequence of ridges and valleys, distinctive reflection light is transmitted to the first concave lens (12) with a black coating on a bottom of the first concave lens (12) to prevent light loss. A diaphragm (16) is formed between a joint between the body (6) and the sensing device (8) to control focusing of the reflected light from the first concave lens (12). In order to reinforce the light focusing effect, a rear face of the diaphragm (16) is coated with black. Thereafter, the light is reflected by the second concave lens (14) to the sensor (10). Because the reflection light path is designed based on TIR, the distinctive light of the fingerprint is totally reflected by both the first concave lens (12) and the second lens (14) and received by the sensor (10), the sensor (10) is able to compare the received light pattern with what is stored inside a memory bank so as to distinguish the identity of whom the fingerprint belongs to.

The location of the light source (4) is offset to where the objective lens (11) is located and the position of the first concave lens (12) is offset to the objective lens (11). Further, the position of the second concave lens (14) is offset to where the first concave lens (12) is located. Therefore, TIR is successfully accomplished.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fingerprint identification assembly comprising:
a body having an objective lens mounted on top of the body for receiving thereon a fingertip and a first reflective lens mounted on a bottom of the body to receive reflected light from the objective lens;
a light source emitting light to the first reflective lens; and
a sensing device integrally formed with the body to receive the reflected light from the first reflective lens and a sensor to receive the reflected light from the first reflective lens so as to compare the received reflected light with information stored inside the sensor.

2. The assembly as claimed in claim 1, wherein the objective lens is made of a transparent material.

3. The assembly as claimed in claim 2, wherein the material for making the objective lens is selected from a group consisting of glass or acrylic resin.

4. The assembly as claimed in claim 1 further comprising a diaphragm mounted at a joint between the body and the sensing device, wherein a rear face of the diaphragm is coated with black.

5. The assembly as claimed in claim 3 further comprising a diaphragm mounted at a joint between the body and the sensing device, wherein a rear face of the diaphragm is coated with black.

6. The assembly as claimed in claim 5, wherein the first reflective lens and the second reflective lens are concave lenses.

7. The assembly as claimed in claim 6, wherein a position of the light source is offset to where the objective lens is located, a position of the objective lens is offset to where the first reflective lens is located and a position of the first reflective lens is offset to where the second reflective lens is located.

8. The assembly as claimed in claim 6, wherein the objective lens is parallel to a ground surface.

9. The assembly as claimed in claim 7, wherein the objective lens is parallel to a ground surface.

10. The assembly as claimed in claim 1, wherein the objective lens is inclined to a ground surface.

11. The assembly as claimed in claim 2, wherein the objective lens is inclined to a ground surface.

12. The assembly as claimed in claim 3, wherein the objective lens is inclined to a ground surface.

13. The assembly as claimed in claim 5, wherein the objective lens is inclined to a ground surface.

14. The assembly as claimed in claim 6, wherein the objective lens is inclined to a ground surface.

15. The assembly as claimed in claim 7, wherein the objective lens is inclined to a ground surface.

16. A fingerprint identification assembly comprising:
a body having an objective lens mounted on top of the body for receiving thereon a fingertip, a first reflective lens for receiving reflected light from the fingerprint and a second reflective lens mounted on a bottom of the body to receive reflected light from the first objective lens;
a light source emitting light to the first reflective lens; and
a sensing device integrally formed with the body to receive the reflected light from the first reflective lens and a sensor to receive the reflected light from the first reflective lens so as to compare the received reflected light with information stored inside the sensor, wherein the first reflective lens and the second reflective lens are concave lenses.

17. The assembly as claimed in claim 16, wherein the objective lens has a width configured in such a manner that the fingerprint is stored in the sensor only when the finger is moved back and forth.
